(19) United States
(12) Patent Application Publication
(10) Pub. No.: US 2009/0104991 A1
(43) Pub. Date: Apr. 23, 2009

(54) GAMING DEVICE DISPLAY AND METHOD

(76) Inventors: Jerald C. Seelig, Absecon, NJ (US); Lawrence M. Henshaw, Hammonton, NJ (US)

Correspondence Address: IAN F. BURNS & ASSOCIATES, 4790 Caughlin Parkway #701, RENO, NV, 89519-0907, US

(21) Appl. No.: 12/043,622

(22) Filed: Mar. 6, 2008

Related U.S. Application Data
(60) Provisional application No. 61/013,016, filed on Dec. 12, 2007.
(60) Provisional application No. 60/981,495, filed on Oct. 20, 2007.

(51) Int. Cl. A63F 9/24; A63F 13/10

(52) U.S. Cl. 463/33; 463/37; 463/1; 463/31

(57) ABSTRACT

A gaming apparatus is disclosed that comprises a plurality of gaming devices and a display. The display provides at least one video display mounted on a rotatable structure. An actuator rotates the rotatable structure so that the video display can be viewed by players of the gaming devices. A display controller controls the display to select the presentation shown on the video display. Where multiple video displays are provided, the display controller controls the video display so that a video display entering a segment of the rotation path continues a presentation of a video display exiting the segment such that a player within the segment is able to view a continuous presentation.

### CROSS REFERENCES TO RELATED APPLICATIONS

This application claims priority of U.S. provisional patent application No. 61/013,016, filed Dec. 12, 2007, and U.S. provisional patent application No. 60/981,495, filed Oct. 20, 2007. All of the above referenced applications are hereby expressly incorporated by reference in their entireties.

### FIELD OF THE INVENTION

The present invention relates to gaming systems and methods of playing gaming devices. More particularly the present invention relates to gaming systems incorporating video displays.

### BACKGROUND

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device may present the outcome of the game on a large variety of display devices, of which a video screen depicting spinning reels is the most common.

One problem with a typical video reel slot machine is that in general they all look the same. Typically, the only difference between reels from one gaming machine to another is the look of the indicia of the reels. This similarity between gaming machines can lead to these machines being ignored by game players and to player boredom, resulting in less revenue to the casino operator.

In order to enhance player enjoyment highly visible display devices are utilized on gaming devices in order to attract players. Once players are attracted to the gaming device, they tend to play longer because the display device enhances the stimulation and excitement experienced by players. It is, therefore, desirable for gaming devices to incorporate highly visible display devices.

Although video devices and electronic signs can be used for display devices, players are more attracted to display devices that utilize physical movement, such as described in the Applicant's co-pending applications Ser. Nos. 10/937,018 and 10/883,489, the entire contents of which are specifically incorporated herein by reference. However, display devices that utilize the movement of physical objects are at a disadvantage to video displays because a video display allows the display presentation to be regularly updated, therefore preventing the tendency of a player to become bored with a game.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide longer play times for a player;

provide greater revenues for gaming operators;

provide a gaming device that utilizes a visually appealing and highly visible display device;

provide a video display having a variable presentation; and

provide a video display that incorporates physical movement to attract a player.

These and other advantages may be realized by reference to the remaining portions of the specification, claims, and abstract.

### Brief Description of One Embodiment of the Present Invention

In one aspect, the invention relates to a gaming system providing a rotatable display apparatus, a plurality of gaming devices positioned proximate to the rotatable display apparatus and a display controller. The display apparatus comprises at least one rotatably supported video display and at least one actuator coupled to the video display, the actuator being configured to rotate the video display. The display controller may be in communication with each of the gaming devices and the video display. The display controller is operative to detect when a video display event has occurred, cause the video display to display a video presentation and cause the actuator to rotate the video display. When the video display is rotated, players playing the gaming devices may see the rotating video display.

In one aspect, the invention relates to a method of playing a game at one or more of a plurality of gaming devices. The method comprises determining the occurrence of a video display event and selecting one or more of a plurality of video displays. One or more video presentations may be displayed on the selected video displays and the video displays may be rotated relative to the one or more gaming devices.

In one aspect, the invention relates to a method of playing a game in which a player places a wager and plays a game at at least one gaming device to determine an outcome of the game. The method also includes rotating at least one video display and causing a presentation to be displayed on the video display.

In one aspect, the invention relates to a method of playing a game apparatus, the game apparatus having a plurality of gaming devices and a display apparatus. The display apparatus has at least one rotatably supported video display, at least one actuator coupled to the video display and configured to rotate the video display along a rotation path. The rotation path has a plurality of segments, each segment associated with one of the plurality of gaming devices. A video presentation may be associated with each segment. The method comprises determining when the video display enters one of the segments and causing the video display to display a presentation associated with the entered segment.

In one aspect, the invention relates to a display for displaying game information to a plurality of gaming devices. The display comprises one or more video display means, means for rotating the video display means relative to the gaming devices and means for causing at least one video presentation to be displayed on the one or more video display means.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic plan view of one embodiment of the gaming apparatus of the present invention;

FIG. 2 is substantially a schematic side view of a display apparatus;

FIG. 3 is substantially a connection outline of a display apparatus;

FIG. 4 is substantially a schematic view of a video display;

FIG. 5 is substantially a flowchart of a method of playing a game in accordance with one embodiment of the present invention; and

FIG. 6 is substantially a schematic side view of a display apparatus in accordance with an alternative embodiment of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention comprises a gaming apparatus, shown schematically in plan view in FIG. 1 and generally indicated by reference numeral 10. The gaming apparatus 10 includes a plurality of gaming devices 12a, 12b, 12c, 12d referred to collectively herein by reference numeral 12. While FIG. 1 illustrates four gaming devices 12, the person skilled in the art will readily understand that any number of gaming devices may be utilized. The person skilled in the art will also readily understand that the invention is not to be limited to any particular gaming device and any gaming device that allows a player to place a wager and play a game may be suitable.

The gaming devices 12 are arranged around a central display 14 which includes rotatable video displays 20a, 20b, 20c, 20d referred to collectively herein by reference numeral 20. While FIG. 1 illustrates four video displays 20, the person skilled in the art will readily understand that any number of video displays may be utilized, in particular the number of video displays need not be equal to the number of gaming devices in some embodiments. As will be described in greater detail below, the central display 14 is configured to rotate about a central axis as indicated by arrow 19 such that the video displays 20 move past the gaming devices 12.

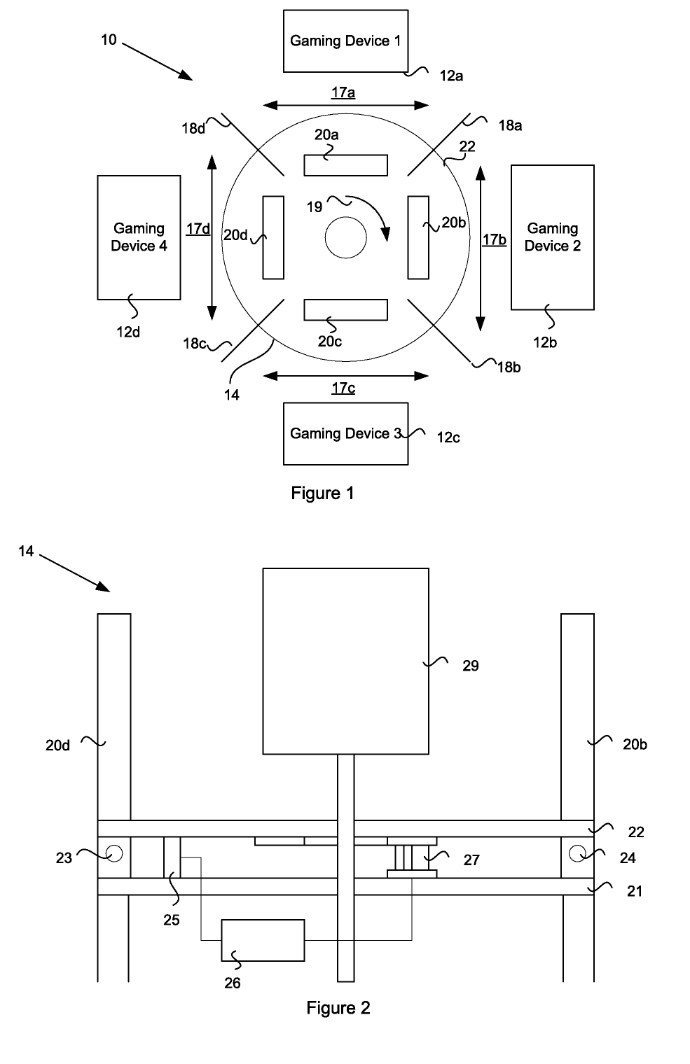

An embodiment of the central display 14 will now be described with additional reference to FIG. 2. The central display 14 includes a support structure 21 that supports a turntable 22 via bearings 23, 24. An actuator 25 provides rotation of the turntable 22 with respect to the support structure 21 in response to signals from a display controller 26. In one embodiment, the actuator 25 incorporates a stepper motor (not shown) that engages the turntable 22 through a drive coupling to rotate the turntable 22.

The turntable 22 supports the video displays 20 of which individual displays 20b, 20d are shown in FIG. 2. Display signals are provided to the video displays 20 from the display controller 26. A rotary connector 27 is provided between the support structure 21 and the turntable 22. The rotary connector 27 maintains data and power connections to the video displays 20 during rotation of the turntable 22. Rotary connections of this kind are known and many suitable connectors are available. In various embodiments, the rotary connector 27 may incorporate sliding contacts such as brushes, slip rings or liquid metal. The rotary connector 27 may also incorporate a rotary coaxial cable for transmitting video signals. An additional backdrop 29, for example for conveying generic game information, may be provided at the centre of the central display 14.

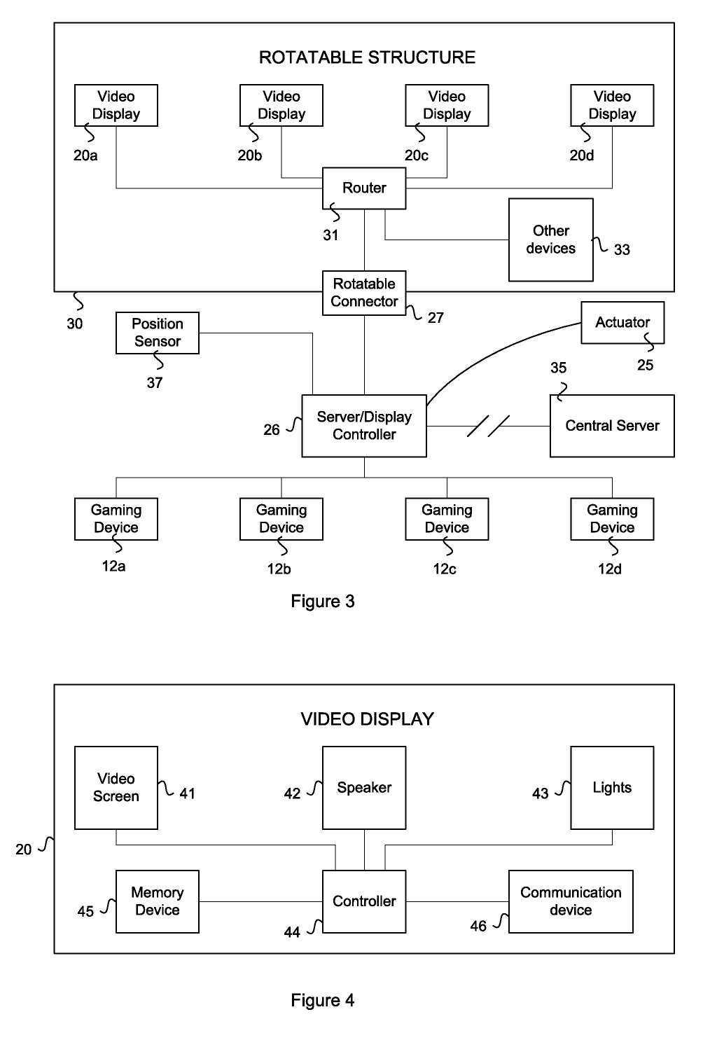

A connection diagram of the gaming apparatus 10 is depicted schematically in FIG. 3. The gaming devices 12a, 12b, 12c, 12d communicate with the server and display controller 26 which also acts as a server for the gaming devices 12. In one embodiment, the server and display controller 26 is self sufficient and controls the gaming devices internally. In one alternative embodiment, the server and display controller 26 communicates with a remote central server 35 via any suitable communications link, for example, a wired or wireless link. The central server 35 may provide gaming control signals to the gaming devices 12 as is known in the art.

The server and display controller 26 is also configured to control the video displays 20a, 20b, 20c, and 20d within a rotatable structure 30. Communication to the video displays 20 is via a router 31 which connects with the server and display controller 26 through the rotary connector 27. The router 31 may also provide power and data to other devices 33, which may include, for example, lighting displays.

Rotation of the rotatable structure 30 is provided by the actuator 25 under the control of the server and display controller 26. The server and display controller 26 may also receive feedback from a position sensor 37 which senses the relative rotational position of the turntable 22.

The video displays 20, shown in more detail in FIG. 4, may be any suitable screen display such as an LCD screen as is known in the art. Each display includes a video screen 41, one or more speakers 42 and optional lights 43. The components of the screen are controlled by a controller 44 in accordance with stored programs that may be stored in memory device 45. A communication device 46, which may be wired or wireless, communicates with the router 31 described above for receiving control signals from the server and display controller 26.

The server and display controller 26 may control the video displays 20 to each show the same presentation or to show different presentations. A presentation may include images displayed on the video screen 41, sounds conveyed by speakers 42 and additional lights 43 as well as combinations of two or more of these elements. In one embodiment, the video presentations may be dependent on a gaming outcome of the gaming devices 12. For example, the video displays 20 may display the outcome of a community prize event or a progressive prize or other major prize winning event of an individual gaming device. For example, community game information may include prizes that are awarded to all players who have qualified to participate in the community game.

In one embodiment, the actuator 25 may be controlled to continuously rotate the rotatable structure 30 including the video displays 20. In an alternative embodiment, the server and display controller 26 may control the actuator 25 to rotate the rotatable structure 30 periodically or when certain gaming outcomes occur at any of the gaming devices 12.

As the video displays 20 rotate, they may change to different presentations. This allows players to see one continuous presentation. For example, with reference to FIG. 1, the rotation path may be divided into segments 17a, 17b, 17c, and 17d corresponding respectively to gaming devices 12a, 12b, 12c, 12d. Divisions 18a, 18b, 18c, 18d, which may be visible partitions or nominal i.e., virtual partitions, divide the rotational path into the respective segments. When video display 20a is in segment 17a, the server and display controller 26 may control video display 20a to display presentation A. When the position sensor 37 indicates that the screen of video display 20a has passed the division 18a between segment 17a and segment 17b, video display 20a switches to presentation B, which was being displayed to the player of gaming device 12b. Under control of the server and display controller 26, video display 20a begins displaying presentation B from the same scene of presentation B where video display 20b stopped displaying presentation B. Concurrently, video display 20d has passed the division 18d into the segment 17a corresponding to gaming device 12a. Video display 20d thus begins showing presentation A where video display 20a stopped showing presentation A. In this way, each player may see a different integral video presentation. Each video presentation may be divided into segments and stored separately in the video display memory device 45. Alternatively, the video presentation segments may be stored in an external memory, such as a memory of the remote central server 35, with the segments being communicated to the relevant video displays when required. The server and display controller 26 coordinates when each display commences showing a presentation and what presentation, or segment of a presentation, a display shows.

Each video display may be pre-programmed with video presentations stored in the memory device 45. The server display controller 26 may cause each video display to display a selected presentation when the display is in a particular segment. The server and display controller 26 can control the timing of the display presentations by monitoring the position of the displays using the position sensor 37.

If the presentations are stored in video display memory device 45 then presentation data need not be transmitted by the server and display controller 26 and only control signals may be transmitted to the video displays. In this embodiment, the control signals may be transmitted over an alternating current power circuit that is also used to provide power to the video displays.

The backdrop 29 may provide a static display or it may provide a video display, such as an organic light emitting diode display, which may have a curved surface for greater aesthetic appeal.

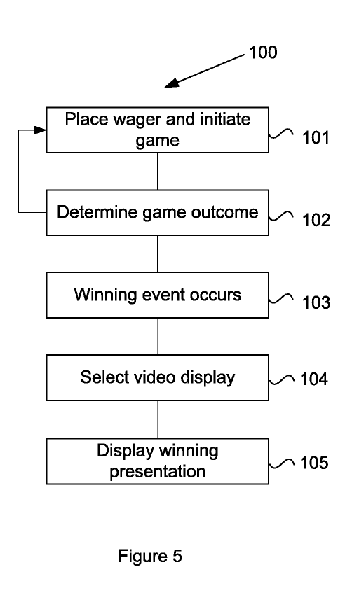

A specific method utilizing the gaming apparatus 10 of FIG. 1 will now be described with reference to the flowchart 100 of FIG. 5. At step 101, a player places a wager in a gaming device, for example gaming device 12a, and initiates a game. The server and display controller 26 then determines a game outcome (step 102). Steps 101 and 102 may be repeated until a winning outcome occurs (step 103). At step 104, the server and display controller 26 uses position sensor 37 to select one of the video displays 20 to be used to present a game winning presentation. In one embodiment, the selected video display is the video display which is currently located in the segment corresponding to the gaming device 12a. The server and display controller 26 then activates the selected display to show a presentation of a winning outcome event (step 105). In one embodiment, prior to presenting the gaming winning outcome, the server and display controller 26 may accelerate the rotation of the video displays 20 in order to center the selected display over the gaming device 12a that generated the winning outcome. The additional rotation of the video displays 20 highlights to all players that a winning outcome has occurred.

In one embodiment, the display that is selected to present the winning outcome presentation may be a display that is outside of the segment 17a corresponding to the winning gaming device 12a. In this embodiment, accelerated rotation of the video displays 20 may be provided to locate the selected display into the segment 17a of the winning gaming device 12a prior to showing the winning presentation on the selected video display.

In addition to displaying the winning presentation on the selected video display, the server and display controller 26 may also cause the other displays to present that a winning outcome has occurred. The additional presentation may indicate which of the players has generated the winning outcome. In one embodiment, the winning outcome may be that a player has qualified for a community prize event. In addition to displaying winning presentations, the video displays may also be controlled to display non-winning presentations, for example when the outcome of a gaming device is a non-winning outcome. Furthermore, the video displays may present standard presentations, for example that correlate to a theme of a gaming device, without being linked to any particular gaming outcome of the gaming device.

In one embodiment, each gaming device may have an associated presentation, for example that correlates to a theme of the respective gaming device. For example, each gaming device may have a bonus game presentation that is presented on a video display when a bonus game event is triggered. The server and display controller 26 ensures that the video display currently viewable by a player of a particular gaming device displays the bonus game presentation for that gaming device when triggered by the gaming device.

In one embodiment, the rotary connector 27 is used only to transmit electrical power. In this embodiment, one or more wireless modems may be provided to allow the video displays to communicate with the display controller via a wireless router.

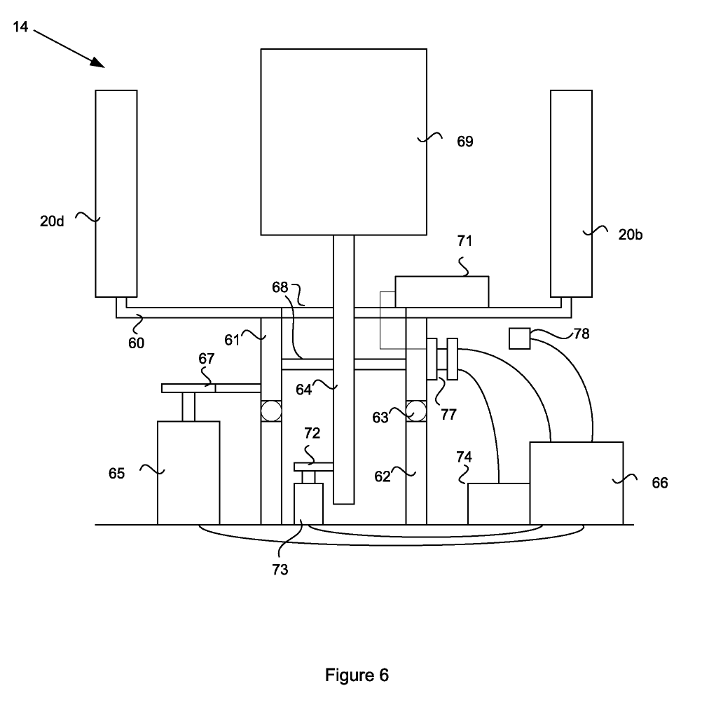

An alternative embodiment is illustrated in FIG. 6. In this embodiment, coaxial shafts include an inner shaft 64 on which a backdrop 69 is mounted and an outer shaft 61 which supports a rotatable structure 60 containing video displays 20, of which video displays 20b, 20d are shown. The coaxial shafts are mounted on a fixed support structure 62 via bearings 63. An actuator 65 connects to the outer shaft 61 via a drive coupling 67 that drives the rotation of the outer shaft 61, thereby causing the rotatable structure 60 to rotate relative to the fixed support structure 62. The actuator 65 receives power from a power supply 74 and control signals from a display controller 66, which may operate the same as the server and display controller 26 as has been described above. A rotary connector 77 is mounted on the outer shaft 61 and provides power and control signals from the power supply 74 and display controller 66 respectively. As described above, a router 71 connects with the rotary connector 77 in order to provide control signals and/or power to the video displays 20.

In the embodiment shown, the inner shaft 64 is fixedly connected to the outer shaft 61 via supports 68 such that the backdrop 69 rotates with the video displays 20. In an alternative embodiment, the supports 68 allow for relative rotation between the inner shaft 64 and the outer shaft 61 and the inner shaft 64 is provided with an actuator 73 and a drive coupling 72 such that the backdrop 69 may be rotated independently of the video displays 20. In one embodiment, the backdrop 69 may be counter-rotating with respect to the video displays. While two actuators are shown, the person skilled in the art will recognize that the inner shaft 64 and the outer shaft 61 may each be rotated from a single actuator, which, if the backdrop 69 is counter-rotating may include a reversing gear (not shown).

Gaming apparatus incorporating a rotating video display has advantage over prior art apparatus by providing physical movement that is able to attract the eye of the game player while also providing a video display which can be regularly updated to show different presentations.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming system comprising:
(A) a display apparatus comprising:
(a) at least one rotatably supported video display; and
(b) at least one actuator coupled to the video display, the actuator being configured to rotate the video display;
(B) a plurality of gaming devices positioned proximate the display apparatus, each gaming device being configured to allow a player to place a wager and play a game;
(C) a display controller in communication with each of the gaming devices, the video display and the actuator, the display controller being operative to:
(a) detect when a video display event has occurred;
(b) cause the video display to display a video presentation; and
(c) cause the actuator to rotate the video display; and
(D) wherein when the video display is rotated, players playing the gaming devices may see the rotating video display.

2. The gaming system of claim 1 wherein the display apparatus comprises a support structure and a plurality of the video displays supported on the support structure, wherein the actuator is coupled to the support structure, the actuator being configured to rotate the support structure.

3. The gaming system of claim 2 wherein the video displays are configured to display portions of one video presentation while in an angular segment of rotation, wherein a player located in the segment may view a single video presentation as the video displays rotate.

4. The gaming system of claim 2 wherein the display controller is operative to:
(A) select at least one video display; and
(B) cause the selected video display to display the video presentation.

5. The gaming system of claim 4 further comprising a position sensor that communicates a position of the video displays to the display controller, wherein the display controller is operative to select the at least one video display dependent on a position of the video displays.

6. The gaming system of claim 5 wherein the display controller is operative to:
(A) determine a gaming device that generated a video display event; and
(B) select the at least one video display dependent on the gaming device that generated the video display event.

7. The gaming system of claim 1 wherein a rotation path of the video display is divided into segments and wherein the display controller controls the display to display at least a portion of a predetermined presentation when the display is in each segment.

8. The gaming system of claim 7 wherein the predetermined presentation is different for each segment.

9. The gaming system of claim 7 wherein each segment is associated with one of the gaming devices and wherein each gaming device has an associated presentation.

10. The gaming system of claim 7 further comprising a position sensor that determines a position of the video display on the rotation path.

11. The gaming system of claim 7 wherein the display controller is operative to cause a video display entering one of the segments to commence showing the predetermined presentation for the one of the segments from a scene of the predetermined presentation that was being shown by a video display exiting the one of the segments.

12. A method of playing a game comprising:
(A) allowing one or more players to place a wager and play a game at one or more of a plurality of gaming devices;
(B) determining the occurrence of a video display event;
(C) in response to the video display event, selecting one or more of a plurality of video displays;
(D) causing one or more video presentations to be displayed on the selected video displays; and
(E) rotating the video displays relative to the one or more gaming devices.

13. The method according to claim 12 further comprising:
(A) determining a position of the plurality of video displays; and
(B) selecting one or more of a plurality of video displays dependent on a position of the plurality of video displays.

14. The method according to claim 12 further comprising:
(A) determining a gaming device that generated the video display event;
(B) rotating a selected video display such that a player at the gaming device that generated the video display event can view a presentation associated with the generated video display event.

15. The method according to claim 14 wherein the presentation associated with the generated video display event is specific to the gaming device that generated the video display event.

16. The method of claim 12 wherein the video displays are rotated along a rotation path and wherein the rotation path is divided into segments, the method further comprising:
(A) determining when an entering video display is entering one of the segments of the rotation path;
(B) determine a scene of a predetermined presentation being shown by an exiting video display that is exiting the one of the segments; and
(C) causing the entering video display to show the predetermined presentation from the scene.

17. A method of playing a game comprising:
(A) allowing a player to place a wager and play a game at at least one gaming device;
(B) determining an outcome of the game;
(C) rotating at least one video display; and
(D) causing a presentation to be displayed on the video display.

18. The method according to claim 17 wherein the presentation is dependent on the outcome.

19. The method according to claim 18 further comprising:
(A) determining a position of the at least one video display; and
(B) rotating the at least one video display to a position viewable by a player at the at least one gaming device.

20. The method according to claim 19 wherein rotating the at least one video display to a position viewable by a player at the at least one gaming device comprises accelerating a rotation of the at least one video display.

21. A method of playing a game apparatus, the game apparatus comprising:
(A) a plurality of gaming devices, each gaming device allowing a player to place a wager and play a game;
(B) a display apparatus comprising:
(a) at least one rotatably supported video display;
(b) at least one actuator coupled to the video display, the actuator being configured to rotate the at least one video display along a rotation path, the rotation path comprising a plurality of segments, each segment associated with one of the plurality of gaming devices; and
(c) a video presentation associated with each segment;
the method comprising:
(C) determine when the at least one video display enters one of the plurality of segments; and
(D) causing the at least one video display to display a presentation associated with one of the plurality of segments.

22. The method according to claim 21 wherein the display apparatus comprises a plurality of the video displays, the method further comprising:
(A) determining a position of the plurality of video displays with respect to the plurality of segments; and
(B) controlling the video displays such that a video display entering a segment continues the presentation of a video display exiting the segment.

23. A display for displaying game information to a plurality of gaming devices, the display comprising:
(A) one or more video display means;
(B) means for rotating the video display means relative to the gaming devices; and
(C) means for causing at least one video presentation to be displayed on the one or more video display means.

24. The display of claim 23 wherein the video display means is configured to display a different video presentation during different portions of its rotation wherein different presentations may be viewed from different angles.

25. The display of claim 23 further comprising position sensing means and display control means controlling a video display presentation of the one or more video display means dependent on a position of the one or more video display means sensed by the position sensing means.
